(19) United States
(12) Patent Application Publication
(10) Pub. No.: US 2011/0147111 A1
(43) Pub. Date: Jun. 23, 2011

(54) ELECTRICAL AUXILIARY MODULE FOR A VEHICLE STEERING SYSTEM

(75) Inventors: Fu-Shin SUN, Chiayi (TW); Jiun-Jie CHEN, Yuanlin Township (TW)

(73) Assignee: AUTOMOTIVE RESEARCH & TESTING CENTER, Lugang Chen (TW)

(21) Appl. No.: 12/645,487

(22) Filed: Dec. 23, 2009

(51) Int. Cl. B62D 5/04

(52) U.S. Cl. 180/444

(57) ABSTRACT

An auxiliary module has a gearbox, a motor, a torque detector and a controller. The gearbox has a casing, a sun gear, a planet gear assembly, a driven gear and a driving axle. The planet gear assembly engages the sun gear and has a driving gear, multiple planet gears and an annular gear. The planet gears are mounted rotatably on the driving gear and engage the sun gear. The annular gear is mounted around and engages the planet gears. The driven gear engages the driving gear. The driving axle is mounted co-axially on the driving gear. The motor is connected co-axially to the sun gear. The torque detector is mounted on the casing of the gearbox with fasteners to detect torque applied on the driving axle. The controller is connected electrically to the motor and the torque detector to adjust torque output from the motor.

### BACKGROUND OF THE INVENTION

1. Field of the Invention

The present invention relates to an auxiliary module, and more particularly to an electrical auxiliary module for a vehicle steering system to improve mechanical efficiency of the steering system.

2. Description of Related Art

An auxiliary device is mounted on a vehicle steering system to provide an auxiliary torque/force for the steering system. However, the conventional auxiliary device is a specific design based on different types or structures of vehicles, so to design and to manufacture a conventional auxiliary device are sophisticated and time-consuming.

With reference to FIG. 9, a conventional pinion type of auxiliary device (70) for a vehicle steering system comprises a gear assembly (72) having a worm gear to transmit power provided by a motor to the steering system. However, the conventional auxiliary device (70) has the following drawbacks.

1. Long design term. The conventional auxiliary device (70) has to be designed and manufactured based on different types and structures of vehicles. The design term for the conventional auxiliary device (70) is long, and molds for manufacturing components of the specific conventional auxiliary device (70) have to be designed accordingly.

2. Low mechanical efficiency. The gear assembly (72) in the conventional auxiliary device (70) comprises a worm rod and a worm gear, but the mechanical efficiency of the conventional gear assembly (72) is low and about 85%. Therefore, the conventional auxiliary device (70) has high power/oil consumption and cost.

3. Troublesome repairing process. To repair or replace damaged component of the conventional auxiliary device (70), the auxiliary device (70) even the whole steering system has to be detached or disassembled. After the repairing or replacing process, the wheels of the vehicle should also be aligned again and this is inconvenient and time-consuming.

To overcome the shortcomings, the present invention tends to provide an electrical auxiliary module to mitigate or obviate the aforementioned problems.

### SUMMARY OF THE INVENTION

The main objective of the invention is to provide an electrical auxiliary module for a vehicle steering system that can be individually detached from the vehicle steering system and has capabilities of easy designing and improving mechanical efficiency.

The auxiliary module comprises a gearbox, a motor, a torque detector and a controller. The gearbox has a casing, a sun gear, a planet gear assembly, a driven gear and a driving axle. The sun gear is mounted rotatably in the casing. The planet gear assembly is mounted in the casing, engages the sun gear and has a driving gear, multiple planet gears and an annular gear. The planet gears are mounted rotatably on the driving gear and engage the sun gear. The annular gear is mounted around and engages the planet gears. The driven gear is mounted rotatably in the casing and engages the driving gear. The driving axle is mounted co-axially on the driving gear and has two ends extending out from the casing. The motor is mounted on the casing of the gearbox with fasteners and is connected co-axially to the sun gear. The torque detector is mounted on the casing of the gearbox with fasteners and is mounted around the driving axle to detect torque applied on the driving axle. The controller is connected electrically to the motor and the torque detector to adjust torque output from the motor according to the torque detected by the torque detector.

Other objects, advantages and novel features of the invention will become more apparent from the following detailed description when taken in conjunction with the accompanying drawings.

### BRIEF DESCRIPTION OF THE DRAWINGS

FIG. 1 is a schematic diagram of a vehicle steering system with an auxiliary module in accordance with the present invention;

FIG. 2 is a perspective view of the auxiliary module in FIG. 1 with a transmission rod of the vehicle steering system;

FIG. 3 is a perspective view of the auxiliary module in FIG. 1;

FIG. 4 is an exploded perspective view of the auxiliary module in FIG. 3;

FIG. 5A is an enlarged perspective view of the planet gear assembly of the auxiliary module in FIG. 4;

FIG. 5B is an exploded perspective view of the planet gear assembly of the auxiliary module in FIG. 4;

FIG. 6 is a side view in partial section of the auxiliary module in FIG. 4;

FIG. 7A is a perspective view of the transmission rod of the vehicle steering system in FIG. 2;

FIG. 7B is a partially exploded perspective view of the transmission rod of the vehicle steering system in FIG. 7A;

FIG. 8A is an exploded perspective view of the auxiliary module with the transmission rod in FIG. 2 showing the auxiliary module being detached from the transmission rod;

FIG. 8B is an exploded perspective view of the auxiliary module with the transmission rod in FIG. 2 showing the motor and the planet gear assembly being detached from the casing of the auxiliary module;

FIG. 8C is an exploded perspective view of the auxiliary module with the transmission rod in FIG. 2 showing the torque detector being detached from the casing of the auxiliary module; and

FIG. 9 is a side view in partial section of a conventional auxiliary module for a vehicle steering system in accordance with the prior art.

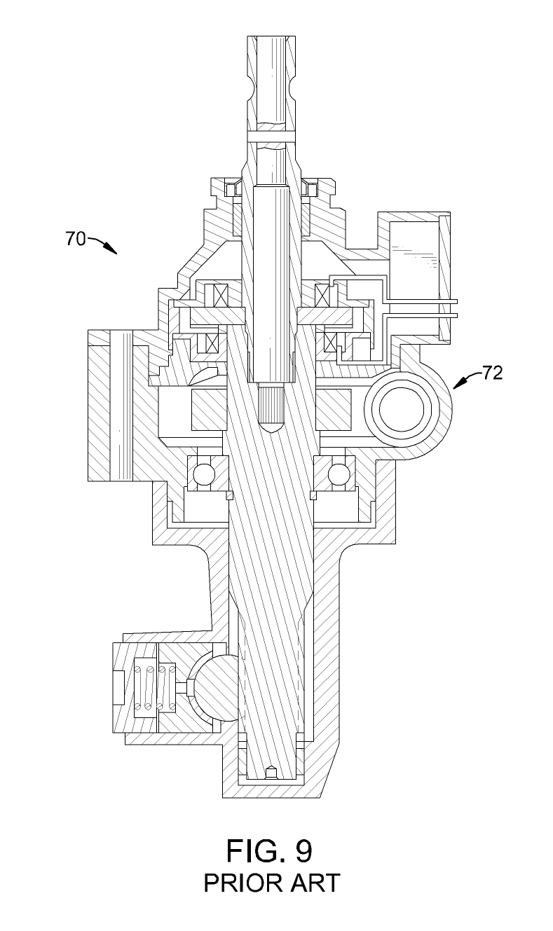

### DETAILED DESCRIPTION OF PREFERRED EMBODIMENT

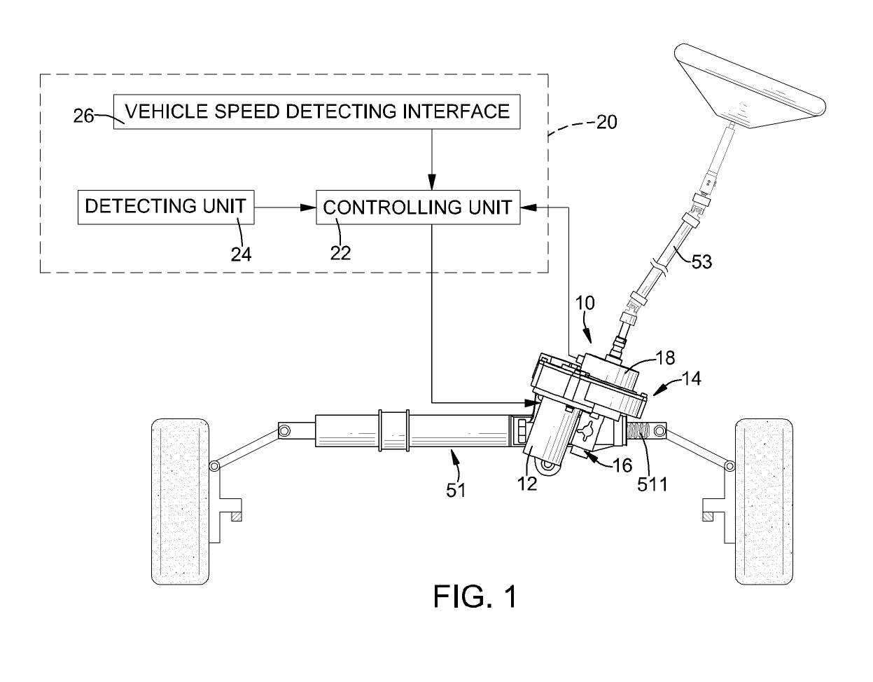

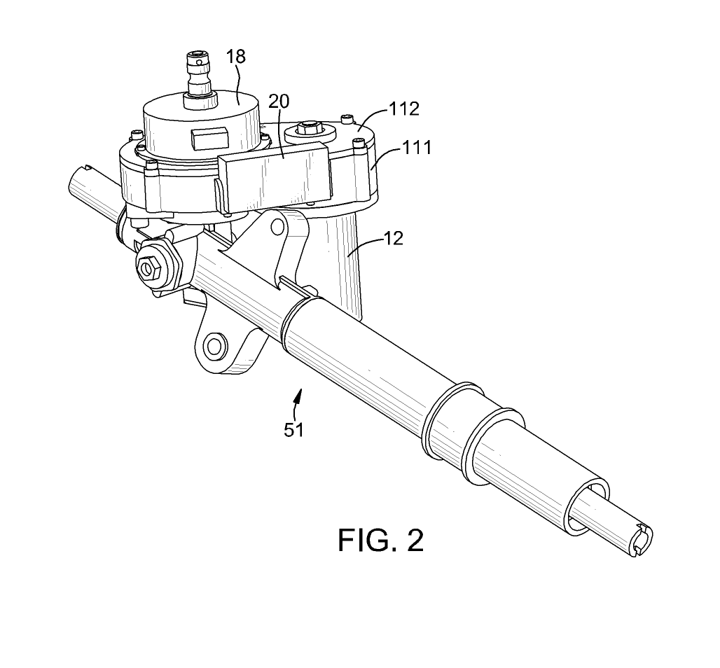

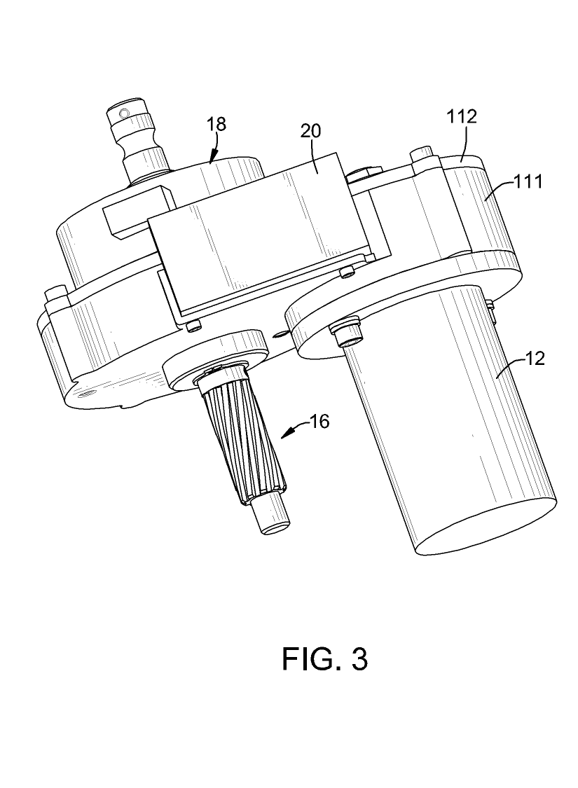

With reference to FIGS. 1 to 4, an electrical auxiliary module (10) for a vehicle steering system in accordance with the present invention comprises a gearbox (14), a motor (12), a torque detector (18) and a controller (20).

The gearbox (14) comprises a casing, a sun gear (121), a planet gear assembly (142), an annular gear (144), a driven gear (146) and a driving axle (16). The casing is mounted securely in a vehicle body, may be mounted securely on a transmission rod (51) of the vehicle steering system and comprises a hollow base (111) and a lid (112) attached securely to a top of the hollow base (111).

The sun gear (121) is mounted rotatably in the casing and is connected to and driven by the motor (12).

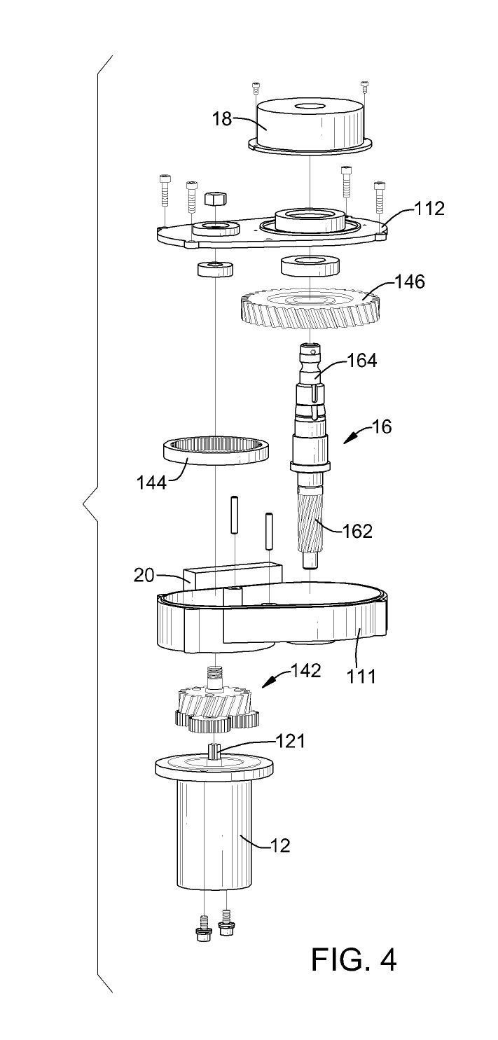

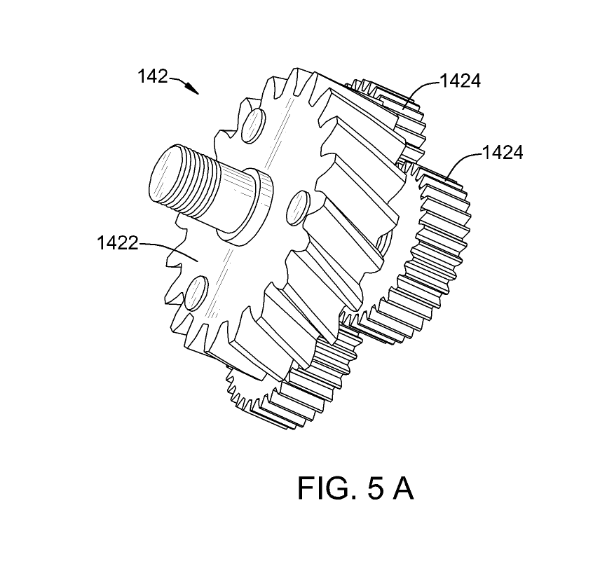

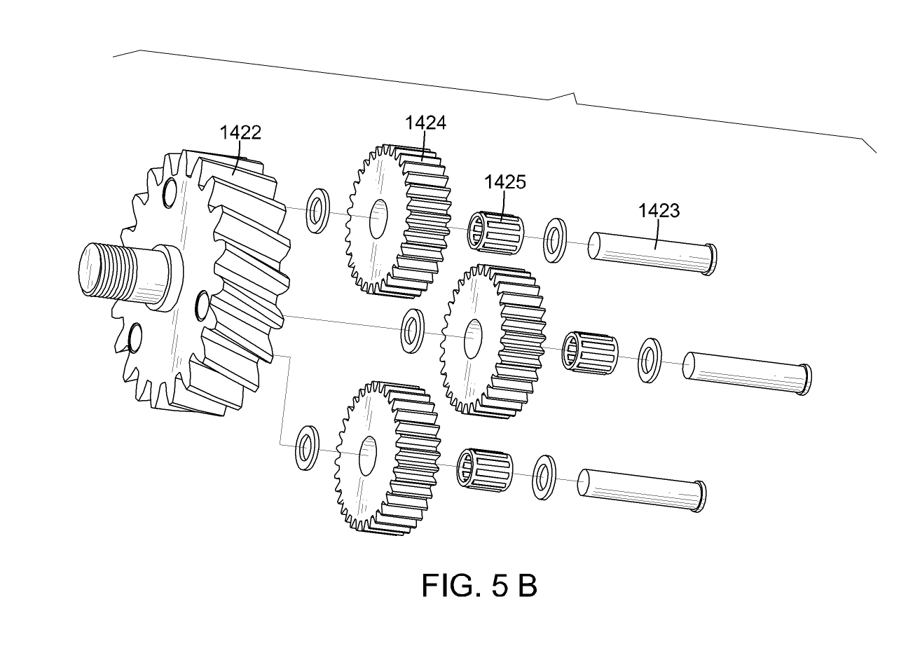

With reference to FIGS. 4, 5A, 5B and 6, the planet gear assembly (142) is mounted in the casing, engages the sun gear (121) and comprises a driving gear (1422) and multiple planet gears (1424). The planet gears (1424) are mounted rotatably on the driving gear (1422) with axles (1423) and bearings (1425) and are mounted around and engage the sun gear (121).

The annular gear (144) is mounted in the base (111) and is mounted around and engages the planet gears (1424). With the arrangement of the annular gear (144), the rotation of the planet gears (1424) is stable, and a gear ratio between the driving gear (1422) and the sun gear (121) can be defined.

The driven gear (146) is mounted rotatably in the casing and engages the driving gear (1422), wherein the driving and driven gear (1422,146) can be helical gears. The gear ratio between the driving and driven gears (1422,146) may be selected based on specifications of different vehicles and may be 2 to 2.5. The gear ratio between the driving and driven gears (1422,146) is various to fit with different needs or designs of vehicles, so the design process and cost can be simplified and reduced.

With further reference to FIG. 1, the driving axle (16) is mounted co-axially on the driving gear (146) and has two ends (162,164) extending out from the casing and including a top end (164) and a bottom end (162). The bottom end (162) of the driving axle (16) is connected to and engages a rail (511) mounted on the transmission rod (51), the top end (164) is connected to a steering rod (53) of the vehicle steering system. Additionally, the driving axle (16) may further have teeth formed on the bottom end (162) of the driving axle (16) to connect to and engage the rail (511) of the transmission rod (51).

The gear ratio relationship between the sun gear (121) and the planet gear assembly (142) of the gearbox (14) is shown as following equation:

φ₁+(N₃₋₁×φ₃)−(N₃₋₁+1)φ₂=0

N₃₋₁=T₃/T₁

Wherein, φ₁ is the angular speed of the sun gear (121), φ₃ is the angular speed of the annular gear (144) (may be zero because the annular gear (144) is stationary), N₃₋₁ is the gear ratio of the sun gear (121) and the annular gear (144), T₁ is the tooth number of the sun gear (121), T₃ is the tooth number of the annular gear (144) and φ₂ is the output angular speed.

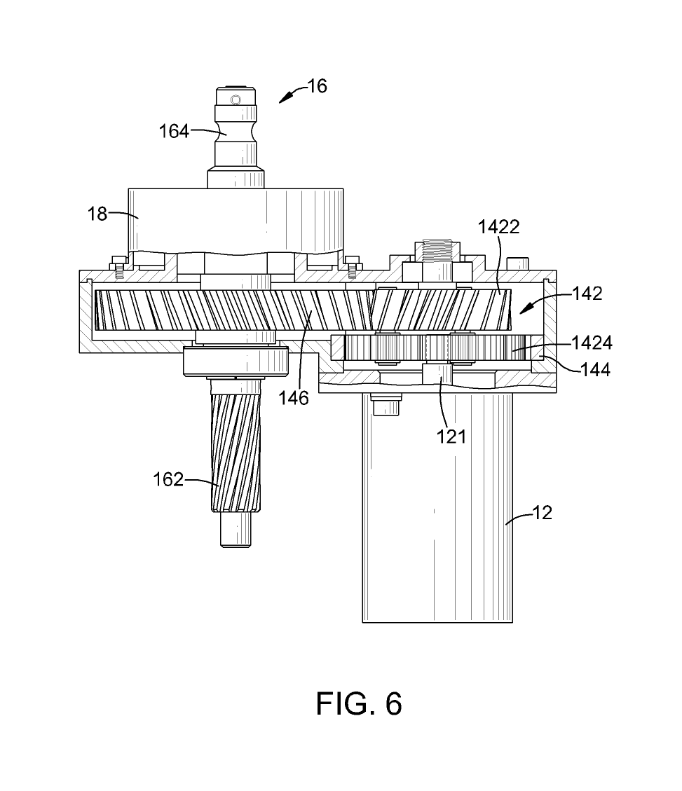

For example, with reference to FIG. 6, if the gear ratio of the planet gear assembly (142) is 1/10 and the gear ratio between the driving and driven gears (1422,146) is ½, the gear ratio between the motor (12) and the driving axle (16) is 1/20. With the various gear ratio between the driving and driven gears (1422,146) of 2 to 2.5, the gear ratio between the motor (12) and the driving axle (16) may be 1/20 to 1/25. Additionally, the gear ratio of the planet gear assembly (142) may also be various, so the gear ratio of the gearbox (14) can be varied to fit with different needs of designs for different vehicles easily and conveniently. With the arrangement of the gearbox (14) with the planet gear assembly (142), the mechanical efficiency of the auxiliary module (10) can be improved to reduce the consumption of power and oil and the cost of using the auxiliary module (10).

The motor (12) is attached securely but detachably to the base (111) of the casing with fasteners, is connected co-axially to the sun gear (121) and has a rotating shaft extending into the base (111) of the casing and connected securely with the sun gear (121).

The torque detector (18) is mounted on the casing of the gearbox (14) with fasteners, is mounted around the top end (164) of the driving axle (16) to detect torque applied on the driving axle (16) and may be an electrical or electromagnetic type or have a torque rod. The torque detector (18) can detect a torque applied onto the steering rod (53) and the top end (164) of the driving axle (16) when a driver rotates a steering wheel and send the detected result to the controller (20).

With reference to FIG. 1, the controller (20) is connected electrically to the motor (12) and the torque detector (18) to adjust torque output from the motor (12) according to the result detected by the torque detector (18). The controller (20) comprises a controlling unit (22), a detecting unit (24) and a vehicle speed detecting interface (26). The detecting unit (24) is connected electrically to the controlling unit (22) and can detect multiple vehicle statuses, such as tire pressure (tire puncture or not) or conditions of an anti-lock braking system (slipping or not) or air bags (bumping against another object or not) and sends the detected signals to the controlling unit (22). The vehicle speed detecting interface (26) can detect the vehicle speed and sends the detected result to the controlling unit (22).

The controlling unit (22) is connected electrically to the motor (12) and the torque detector (18) and receives signals sent from the torque detector (18), the detecting unit (24) and the vehicle speed detecting interface (26) to change the torque provided by and rotating speeds of the rotating shaft of the motor (12). Accordingly, an auxiliary steering effect can be provided to the steering system of the vehicle.

For example, if the driver wants to turn the vehicle and rotates the steering wheel, the torque detector (18) detects the change of torque/resistance between the steering rod (53) and the driving axle (16). The controlling unit (22) determines whether the vehicle is under an unusual or specific condition, such as slipping based on the signals detected by the detecting unit (24) and the vehicle speed detecting interface (26). Accordingly, to reduce or increase the turning torque is judged by the controlling unit (22), and an intelligent auxiliary effect to the steering system is provided.

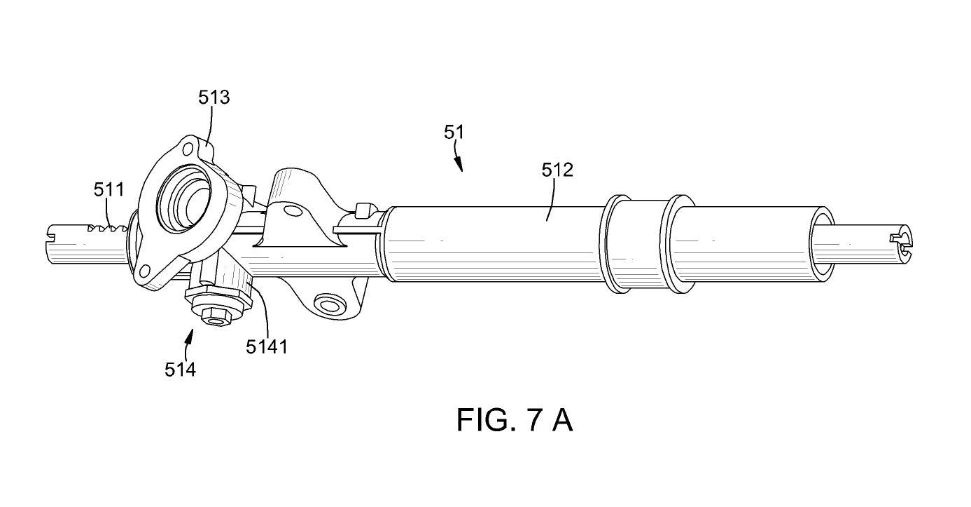

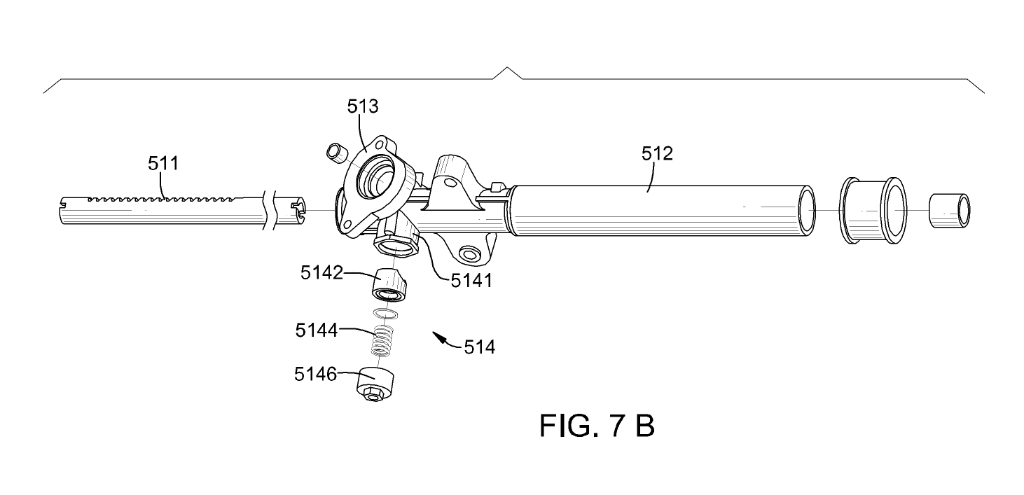

To connect the auxiliary module (10) with the transmission rod (51), with reference to FIGS. 6, 7A and 7B, the transmission rod (51) has a tube (512), a rail (511), a connection base (513) and an adjusting device (514). The rail (511) is mounted movably in the tube (512) and engages the teeth formed on the driving axle (16). The connection base (513) is formed on the tube (512), is connected securely with the casing with fasteners and has a chamber communicating with the tube (512) and allows the bottom end (162) of the driving axle (16) being inserted into the chamber. The adjusting device (514) comprises an adjusting base (5141), a plug (5142), a spring (5144) and an adjusting nut (5146). The adjusting base (5141) is mounted or formed on the tube (512) at a position aligning where the teeth on the driving axle (16) engage the rail (511). The plug (5142), the spring (5144) and the adjusting nut (5146) are mounted in the adjusting base (5141) in sequence. The plug (5142) abuts against the rail (511), and the spring (5144) provides a force to push the plug (5142) abutting against the rail (511). The adjusting nut (5146) is screwed into the adjusting base (5141). When the adjusting nut (5146) is rotated, the spring (5144) will be compressed or released and the force applied to the plug (5142) can be adjusted. Therefore, the engagement force between the driving axle (16) and the rail (511) can be accordingly adjusted. The auxiliary module (10) in accordance with the present invention is modularized and can be deemed as a standard component, and the transmission rod (51) is various based on different needs of designs. Accordingly, the design term for a vehicle steering system with an auxiliary module can be efficiently shortened.

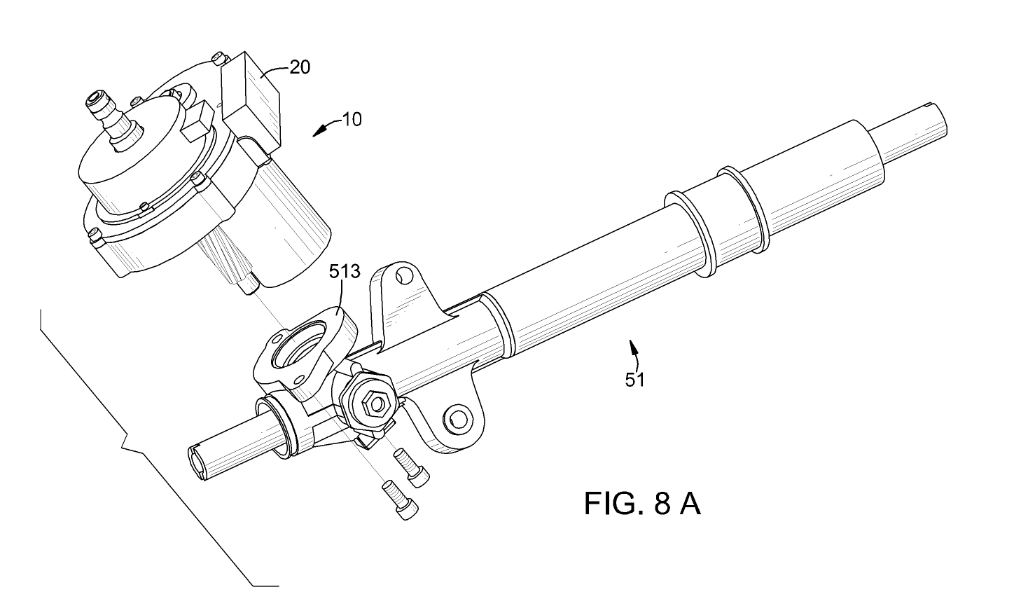

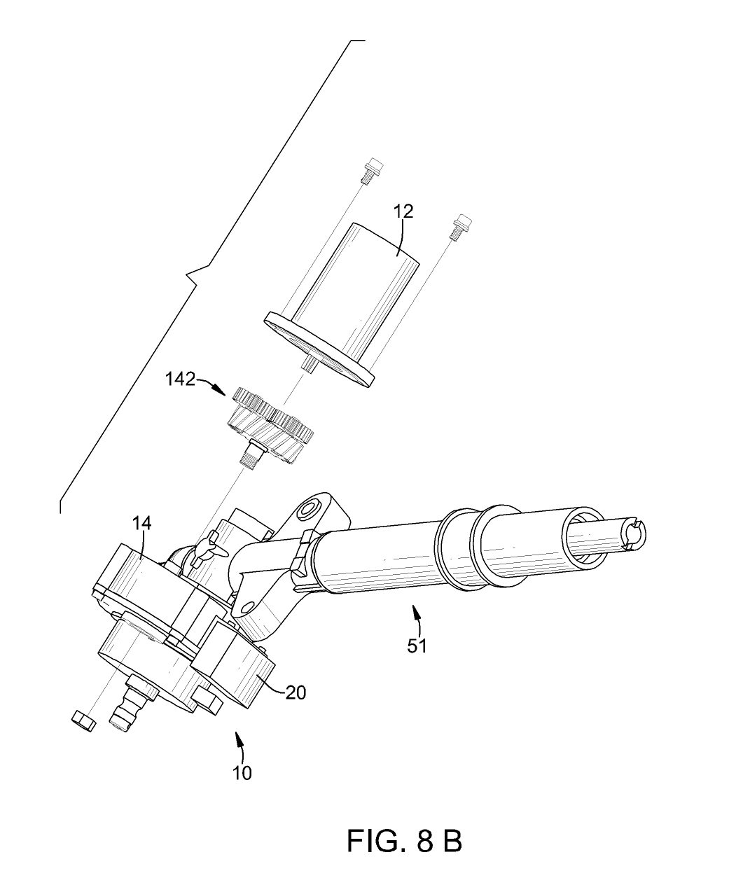

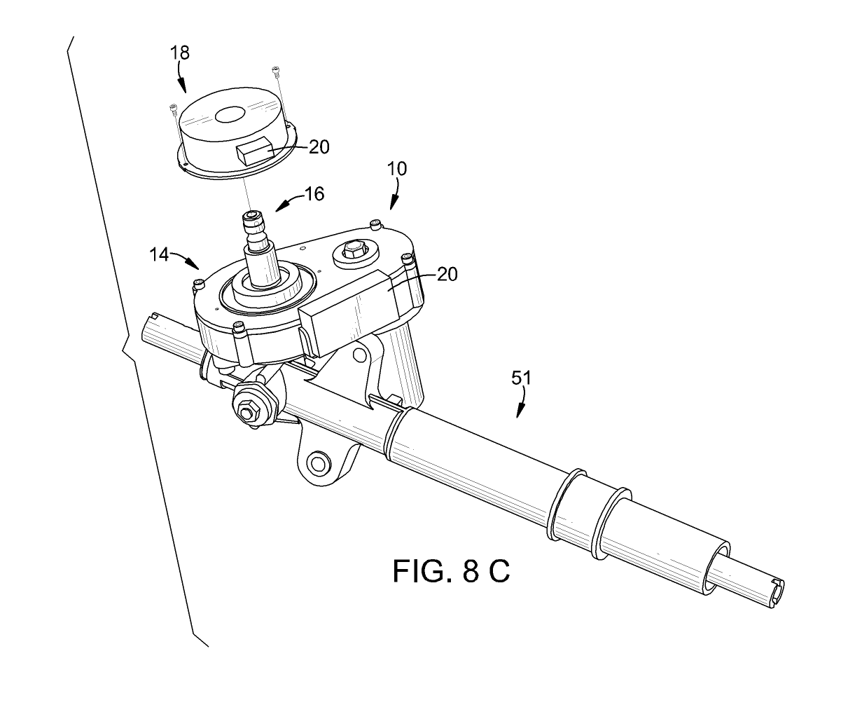

With reference to FIG. 8A, because the casing of the auxiliary module (10) is mounted securely on the connection base (513) on the transmission rod (51) with fasteners, such as bolts, the auxiliary module (10) can be easily and conveniently detached from the connection base (513) for replacement or repair. With reference to FIGS. 8B and C, because the motor (12) and the torque detector (18) are mounted securely on the casing with fasteners, the motor (12), the planet gear assembly (142) and the torque detector (18) can also be individually detached from the casing easily and conveniently. Therefore, to detach or disassemble the whole steering system is unnecessary when some elements of the steering system are damaged, and wheel alignment after repairing or replacing damaged element is also unnecessary.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical auxiliary module for a vehicle steering system comprising:
a gearbox having
a casing;
a sun gear mounted rotatably in the casing;
a planet gear assembly mounted in the casing, engaging the sun gear and having
a driving gear;
multiple planet gears mounted rotatably on the driving gear and engaging the sun gear;
an annular gear mounted around and engaging the planet gears;
a driven gear mounted rotatably in the casing and engaging the driving gear; and
a driving axle mounted co-axially on the driving gear and having two ends extending out from the casing;
a motor mounted on the casing of the gearbox with fasteners and connected co-axially to the sun gear;
a torque detector mounted on the casing of the gearbox with fasteners and mounted around the driving axle to detect torque applied on the driving axle; and
a controller connected electrically to the motor and the torque detector to adjust torque output from the motor according to the torque detected by the torque detector.
